(19) United States
(12) Patent Application Publication
(10) Pub. No.: US 2014/0124499 A1
(43) Pub. Date: May 8, 2014

(54) ELECTRIC HEATING APPARATUS WITH WATERPROOF MECHANISM

(71) Applicants: Chih-Chang WEI, New Taipei City (TW); Etsuro HABATA, New Taipei City (TW)

(72) Inventors: Chih-Chang WEI, New Taipei City (TW); Etsuro HABATA, New Taipei City (TW)

(73) Assignee: BETACERA INC.

(21) Appl. No.: 13/668,321

(22) Filed: Nov. 5, 2012

(51) Int. Cl. H05B 3/06

(52) U.S. Cl. 219/541

(57) ABSTRACT

An electric heating apparatus with a waterproof mechanism includes a hollow tube, a positive temperature coefficient (PTC) heating module and a waterproof glue. The hollow tube has a closed end and an open end; the PTC heating module has a pair of electrode plates, a PTC heating unit included between the pair of electrode plates and a conductive terminal coupled to each electrode plate, and the pair of electrode plates and the PTC heating unit are passed into the hollow tube from the open end; the waterproof glue is filled to seal the open end, and each conductive terminal is exposed from the waterproof glue; so that the waterproof glue sealing the open end of the hollow tube can prevent water vapor from entering into the hollow tube.

### FIELD OF THE INVENTION

The present invention relates to an electric heating apparatus, in particular to the electric heating apparatus with a waterproof mechanism.

### BACKGROUND OF THE INVENTION

In general, an electric heating apparatus is used for providing a heat source for equipments such as dryers, washing machines having laundry and drying functions, indoor warmers, electric heaters, automobile heaters or bathroom dryers.

A conventional electric heating apparatus generally includes a positive temperature coefficient (PTC) heating module, a pair of thermal diffusers and a waterproof glue. The PTC heating module includes a PTC heating unit and a pair of electrode plates coupled to both sides of the PTC heating unit respectively. Each thermal diffuser is coupled to a side of each electrode plate away from the PTC heating unit, and the waterproof glue is coated onto the PTC heating unit and the periphery of each electrode plate to seal the PTC heating unit and each electrode plate between the thermal diffusers in order to prevent water vapor from being contacted with each electrode plate or producing rust or current leakage of the electrode plate.

However, the conventional electric heating apparatus still has the following drawbacks. 1. Since the waterproof glue is provided for sealing the PTC heating unit and each electrode plate between the thermal diffusers, therefore the waterproof glue may produce a gap between the thermal diffusers after a long time of use of the electric heater, and water vapor in contact with each electrode plate may result in rust or current leakage of the electrode plate. 2. The glue may be scratched easily during the process of assembling the electric heating apparatus, so that water vapor in contact with each electrode plate may result in rust or current leakage of electrode plate. Obviously, the aforementioned drawbacks caused by poor water resistance require feasible solutions and improvements.

### SUMMARY OF THE INVENTION

Therefore, it is a primary objective of the present invention to provide an electric heating apparatus with a waterproof mechanism, wherein each electrode plate and each PTC heating unit are passed into a hollow tube and a waterproof glue is filled to seal an open end of the hollow tube to prevent water vapor from entering into the hollow tube, so as to achieve the waterproof effect.

To achieve the aforementioned objective, the present invention provides an electric heating apparatus with a waterproof mechanism, comprising a hollow tube, a PTC heating module and a waterproof glue, wherein the hollow tube has a closed end and an open end;

the PTC heating module has a pair of electrode plates, a PTC heating unit included between the pair of electrode plates, and a conductive terminal coupled to each of the electrode plates, and the pair of electrode plates and the PTC heating unit are passed into the hollow tube from the open end; and the waterproof glue is filled to seal the open end, and each of the conductive terminals is exposed from the exterior of the waterproof glue.

The present invention further has the following advantages. 1. The hollow tube is provided for achieving the grounding effect and preventing electromagnetic interference of the electrode plates. 2. The thermal adhesive has the characteristics of an electrically conductive material to enhance the efficiency for each electrode plate to transmit electric energy to the PTC heating unit and improve the heating effect. In addition, the thermal conductivity of the thermal adhesive and the thermal insulation adhesive improves the effect of transmitting the heat generated by the PTC heating unit to the thermal diffusers. 3. Each thermal insulation plate with an electric insulation between each electrode plate and the inner surface of the hollow tube can prevent electric energy of each electrode plate from leaking to the hollow tube, so as to achieve the effect of preventing current leakage. 4. The metal plate comes with a plurality of long concave marks or a plurality of cut grooves to increase the contact area of each fin with the air, so as to improve the heat exchange effect and enhance the heating effect of the heater. In addition, the thickness of the fins can be reduced to lower the material cost. 5. A fixing frame is provided for achieving the effect of positioning the PTC heating unit. 6. The thermal insulation plate is comprised of a primary insulation unit and a plurality of secondary insulation units to reduce the thickness of the thermal insulation plate.

### BRIEF DESCRIPTION OF THE DRAWINGS

FIG. 1 is an exploded view of a first preferred embodiment of the present invention;

FIG. 2 is a schematic view of a fin of the first preferred embodiment of the present invention;

FIG. 3 is a perspective view of the first preferred embodiment of the present invention;

FIG. 4 is a schematic view of a thermal insulation plate of he first preferred embodiment of the present invention;

FIG. 5 is a cross-sectional view of the first preferred embodiment of the present invention;

FIG. 6 is a cross-sectional blowup view of the first preferred embodiment of the present invention;

FIG. 7 is a schematic view of an application of the first preferred embodiment of the present invention;

FIG. 8 is a first schematic view of a hollow tube of a second preferred embodiment of the present invention;

FIG. 9 is a second schematic view of a hollow tube of the second preferred embodiment of the present invention;

FIG. 10 is a first schematic view of a hollow tube of a third preferred embodiment of the present invention;

FIG. 11 is a second schematic view of a hollow tube of the third preferred embodiment of the present invention;

FIG. 12 is a schematic view of a fin in accordance with a fourth preferred embodiment of the present invention;

FIG. 13 is a schematic view of an application of the fourth preferred embodiment of the present invention;

FIG. 14 is a schematic view of a fin of a fifth preferred embodiment of the present invention;

FIG. 15 is a schematic view of a thermal insulation plate of a sixth preferred embodiment of the present invention;

FIG. 16 is a schematic view of a thermal insulation plate of a seventh preferred embodiment of the present invention; and

FIG. 17 is a cross-sectional view of an eighth preferred embodiment of the present invention.

### DESCRIPTION OF THE PREFERRED EMBODIMENTS

The technical contents of the present invention will become apparent with the detailed description of preferred embodiments accompanied with the illustration of related drawings as follows.

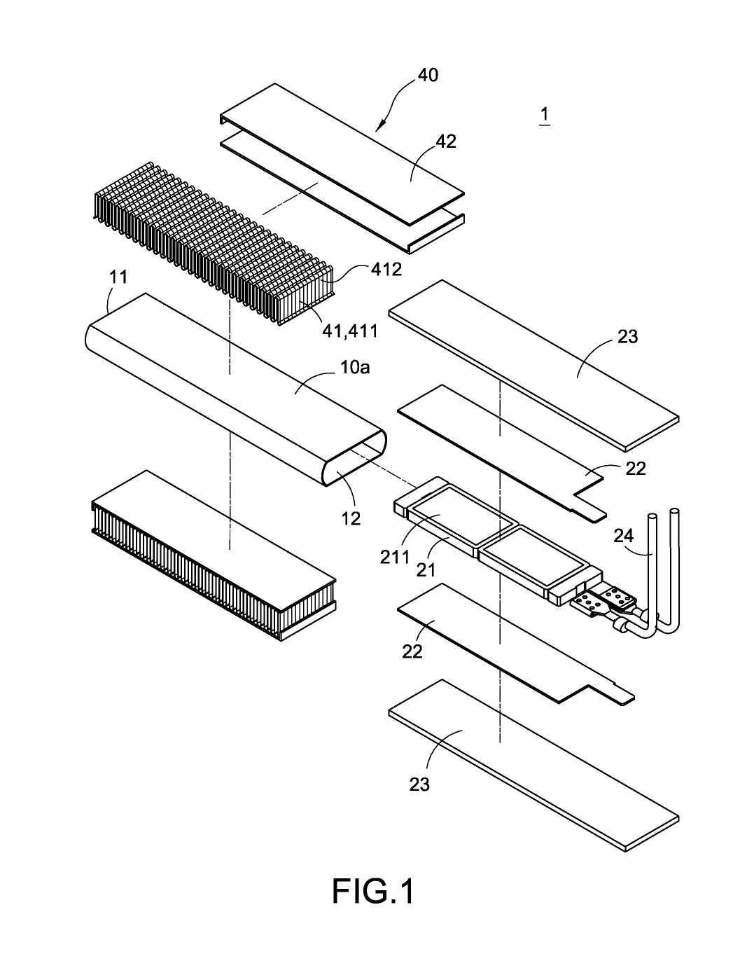

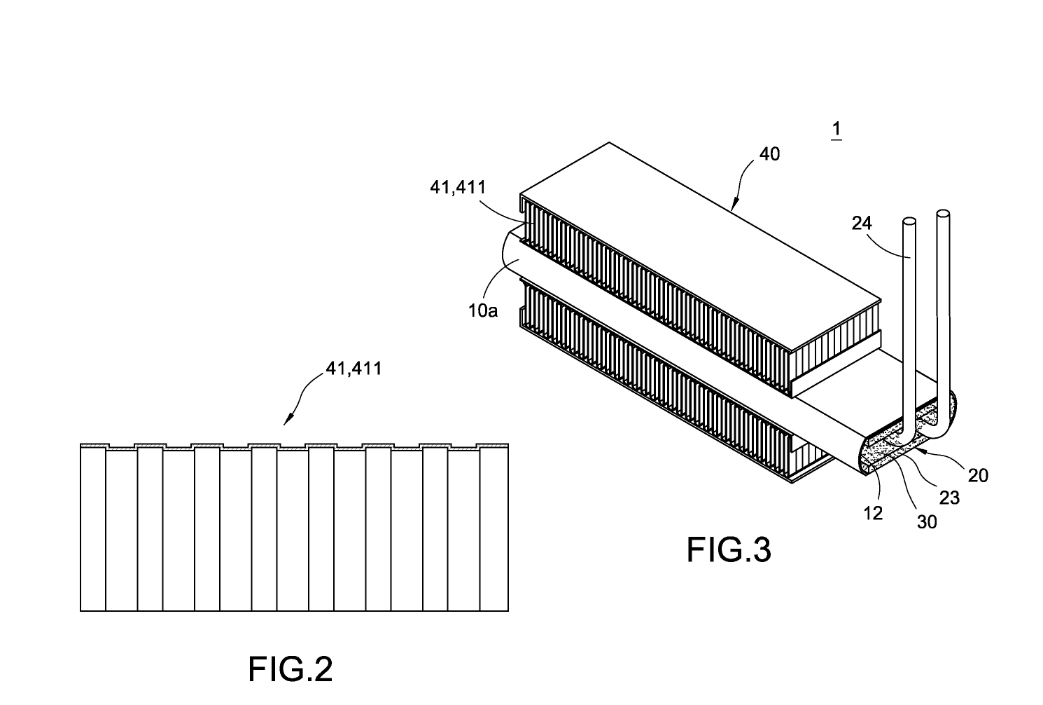

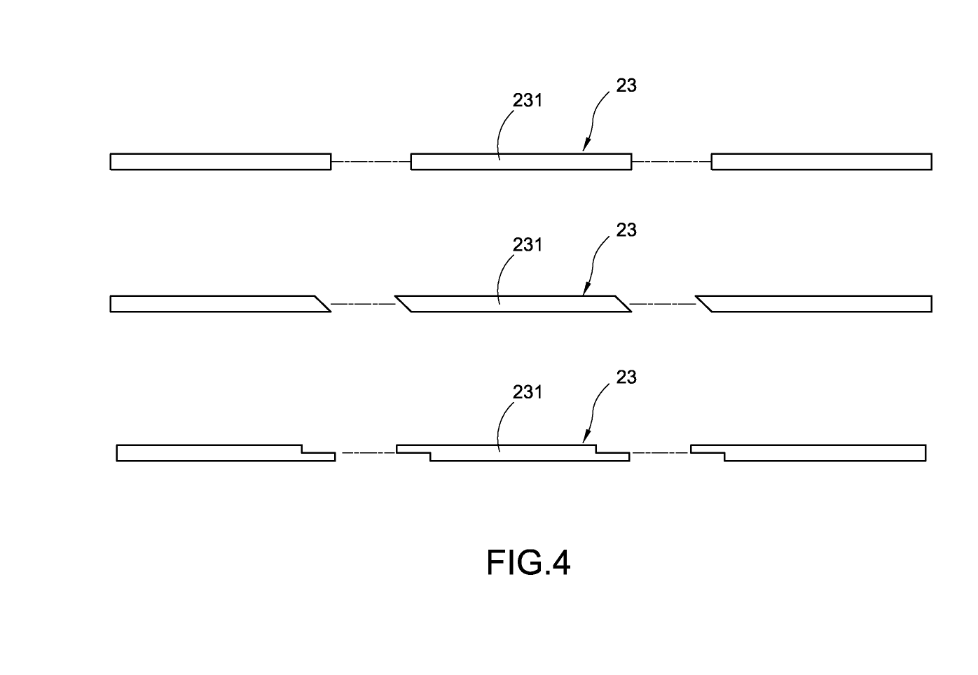

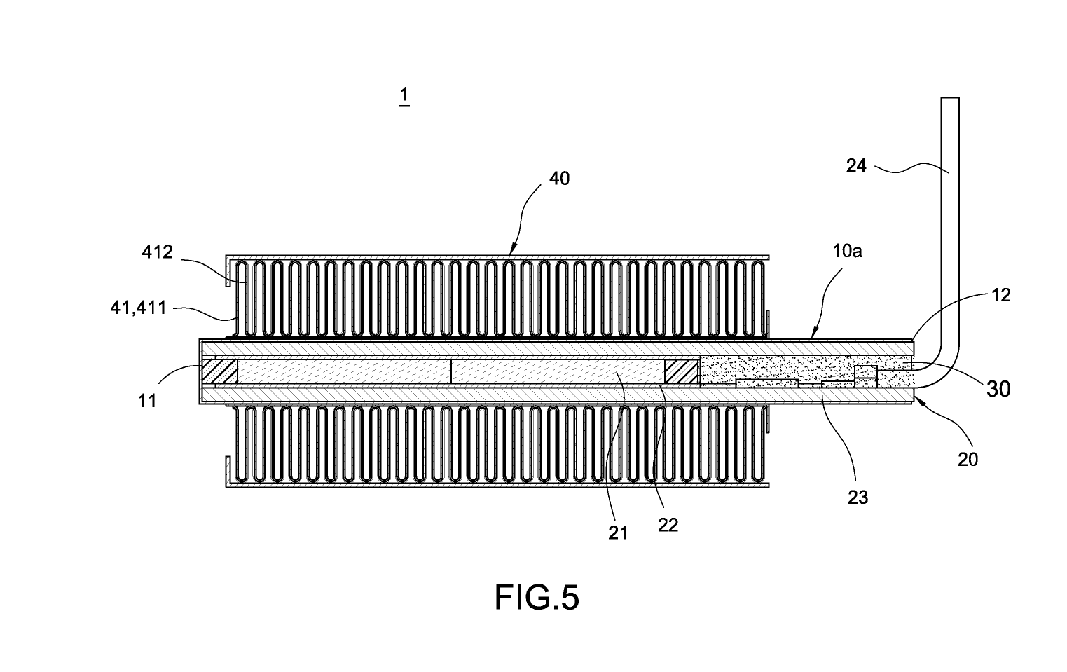

With reference to FIGS. 1 to 5 for an exploded view, a schematic view of a fin, a perspective view, a schematic view of a thermal insulation plate and a cross-sectional view of the first preferred embodiment of the present invention respectively, the present invention provides an electric heating apparatus with a waterproof mechanism 1 comprising a hollow tube 10, a PTC heating module 20 and a waterproof glue 30.

The hollow tube 10 is integrally informed by an extrusion method and made of aluminum or aluminum alloy, and the hollow tube 10 has a closed end 11 and an open end 12.

The PTC heating module 20 is passed into the hollow tube 10a from the open end 12, and the PTC heating module 20 comprises at least one PTC heating unit 21, a pair of electrode plates 22, a pair of thermal insulation plates 23 and a pair of conductive terminals 24; the PTC heating unit 21 is included between the pair of electrode plates 22; an end of each conductive terminal 24 is coupled to an end of each electrode plate 22, and a side of each conductive terminal 24 away from each electrode plate 22 is exposed from the exterior of the open end 12 of the hollow tube 10a; wherein the PTC heating unit 21 is made of a ceramic material with a positive temperature coefficient, and each electrode plate 22 and each conductive terminal 24 are made of copper or copper alloy.

Each thermal insulation plate 23 is included between each electrode plate 22 and an inner surface of the hollow tube 10a and formed by arranging and connecting a plurality of insulation units 231 with one another, wherein each insulation unit 231 is in the form of a rectangular, parallelogram or T-shaped body, and each insulation unit 231 is a unit made of aluminum oxide, aluminum nitride, silicon nitride or silicon carbide.

The waterproof glue 30 is made of a material including but not limited to silicone or rubber, and the waterproof glue 30 is filled to seal the open end 12 of the hollow tube 10a, and each conductive terminal 24 is exposed from the exterior of the waterproof glue 30 to achieve the effect of preventing water vapor outside the hollow tube 10a from entering into the hollow tube 10a, and the water vapor may cause rust or damage each electrode plate 22 or damage the PTC heating unit 21 that may result in a short circuit and short service life of the electric heating apparatus 1, and thus the waterproof glue 30 filled to seal the open end 12 of the hollow tube 10a can improve the waterproof effect and enhance the service life of the electric heating apparatus 1.

Each thermal diffuser 40 has a plurality of fins 41 and a pair of fixed plates 42, and each fin 41 is formed by a wavy metal plate 411, and a plurality of long concave marks 412 is formed on a side of each metal plate 411, but the invention is not limited to such arrangement only. Each fixed plate 42 is coupled separately to both sides of each fin 41, wherein each metal plate 411 and each fixed plate 42 are made of aluminum or aluminum alloy.

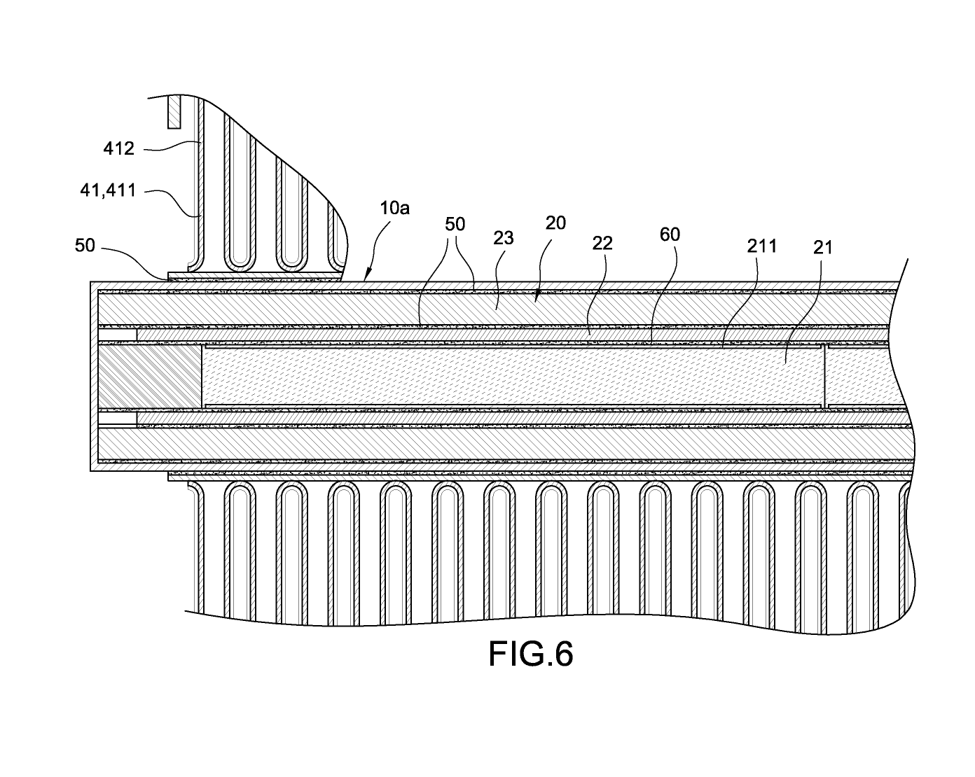

With reference to FIG. 6 for a cross-sectional blowup view of the first preferred embodiment of the present invention, the electric heating apparatus 1 further comprises a pair of thermal diffusers 40, a thermal insulation adhesive 50 and a thermal adhesive 60, and the thermal diffusers 40 are coupled to external surfaces on both sides of the hollow tube 10a respectively by the thermal insulation adhesive 50 through the insulating method.

The thermal adhesive 50 is made of silicone, epoxy resin or plastic, and an electrically conductive material including but not limited to copper and silver can be added to the thermal adhesive 50, and each electrode plate 22 is attached separately onto both sides of the PTC heating unit 21 by the thermal adhesive 50. To increase the adhesion of the thermal adhesive 50 with the PTC heating unit 21, a metal layer 211 is coated onto both surfaces of the PTC heating unit 21 to increase the surface roughness of both sides of the PTC heating unit 21, such that the thermal adhesive 50 can be attached securely onto the surfaces on both sides of the PTC heating unit 21, wherein the metal layer 211 is made of aluminum or aluminum alloy.

The thermal insulation adhesive 50 is a substrate material added with a ceramic power, wherein the substrate material is silicone, epoxy resin or plastic, and the ceramic powder is aluminum oxide, silicon nitride, aluminum nitride or silicon carbide, and each thermal insulation plate 23 has a side attached onto each electrode plate 22 by the thermal insulation adhesive 50 through an insulating method and the other side attached onto an inner surface of the hollow tube 10a by the thermal insulation adhesive 50 through the insulating method.

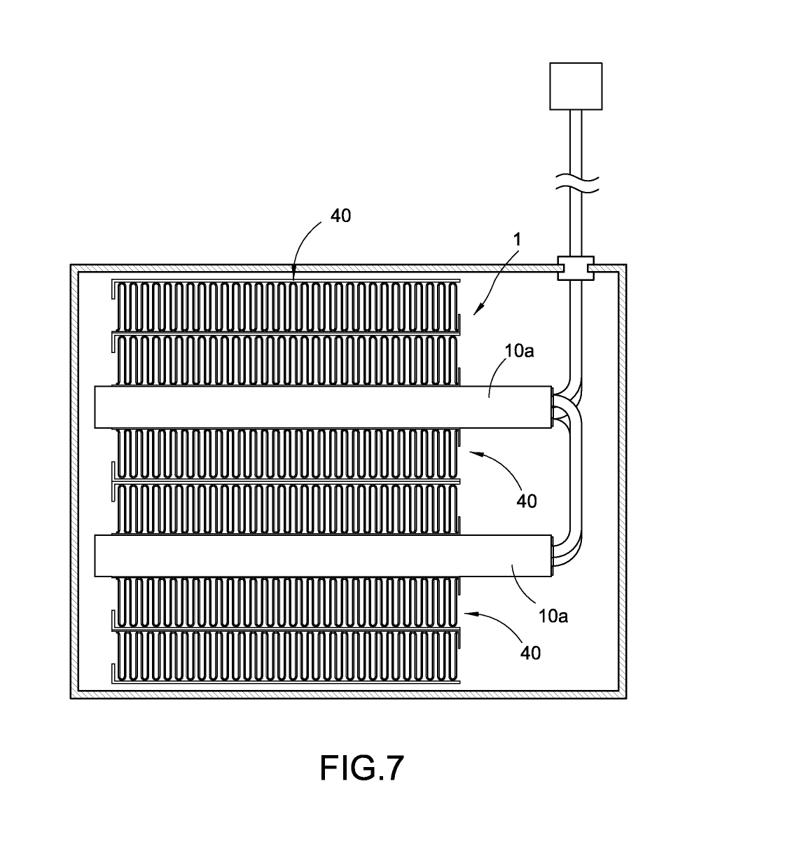

With reference to FIG. 7 for a schematic view of an application of the first preferred embodiment of the present invention, the pair of conductive terminals 24 are connected to a power supply to transmit electric power to each electrode plate 22, and the electric power is transmitted to the PTC heating unit 21 through each electrode plate 22. Since the PTC heating unit 21 is made of a ceramic material with a positive temperature coefficient, therefore the resistance is very large, and the electric power can be converted into heat energy easily, and the heat energy is transmitted by each electrode plate 22 to each thermal insulation plate 23 and then transmitted by each thermal insulation plate 23 to the hollow tube 10a, and further transmitted to each thermal diffuser 40 through the hollow tube 10a, and finally each thermal diffuser 40 performs a heat exchange with air to achieve the effect of heating the air.

However, the thermal adhesive 60 has the thermal and electrical conduction effects, so that the efficiency of each electrode plate 22 transmitting electric power to each PTC heating unit 21 can be improved to enhance the efficiency of each PTC heating unit 21 converting electric energy into heat energy and improve the effect of transmitting the heat generated by each PTC heating unit 21 to each electrode plate 22.

In addition, each thermal insulation plate 23 with the electric insulation property and installed between each electrode plate 22 and the inner surface of the hollow tube 10a can prevent the electric energy of each electrode plate 22 from leaking to the hollow tube 10a, so as to achieve the effect of preventing electric leakage. Wherein, the thermal insulation plate 23 has the thermal conduction effect, so that the performance of each electrode plate 22 transmitting heat energy to the hollow tube 10a can be enhanced. In addition, the thermal insulation adhesive 50 has a high thermal conductivity to improve the effect of each electrode plate 22 transmitting heat energy at the each thermal insulation plate 23, each thermal insulation plate 23 transmitting heat energy to the hollow tube 10a, and the hollow tube 10a transmitting heat energy to each thermal diffuser 40.

In addition, the hollow tube 10a further has the grounding effect and resists electromagnetic interference.

In addition, each long concave mark 412 formed on a side of the fin 41 increases the contact area of each fin 41 with air to improve the effect for each thermal diffuser 40 performing a heat exchange with air, so that the heat of the thermal diffuser 40 can be conducted to the air more quickly to improve the effect of heating the air. In addition, the thickness of the fin 412 can be reduced to 0.2 cm. Compared with the thickness of the conventional fin equal to 0.28 cm, the invention can lower the material cost effectively.

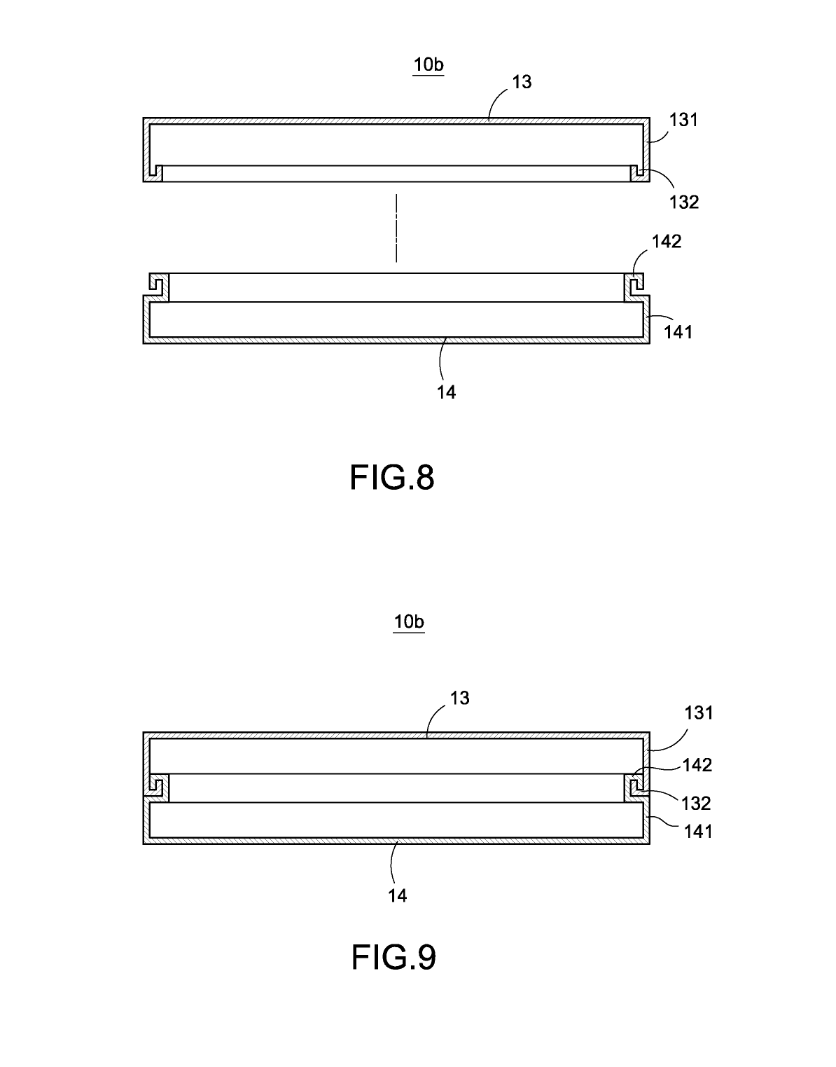

With reference to FIGS. 8 and 9 for the first and second schematic views of a hollow tube of the second preferred embodiment of the present invention, the difference between this preferred embodiment and the previous preferred embodiments resides on that the hollow tube 10a is changed to a hollow tube 10b, wherein the hollow main body 10b comprises an upper casing 13 and a lower casing 14, and an U-shaped upper vertical plate 131 is formed on a side of the upper casing 13, and an U-shaped lower vertical plate 14 is formed on a side of the lower casing 14, and an inwardly curved upper hook 132 is formed separately on both sides of each upper vertical plate 131, and an outwardly curved lower hook 142 is formed separately on both sides of each lower vertical plate 141, and each upper casing 13 and each lower casing 14 are engaged with each other by each upper hook 132 and each lower hook 142.

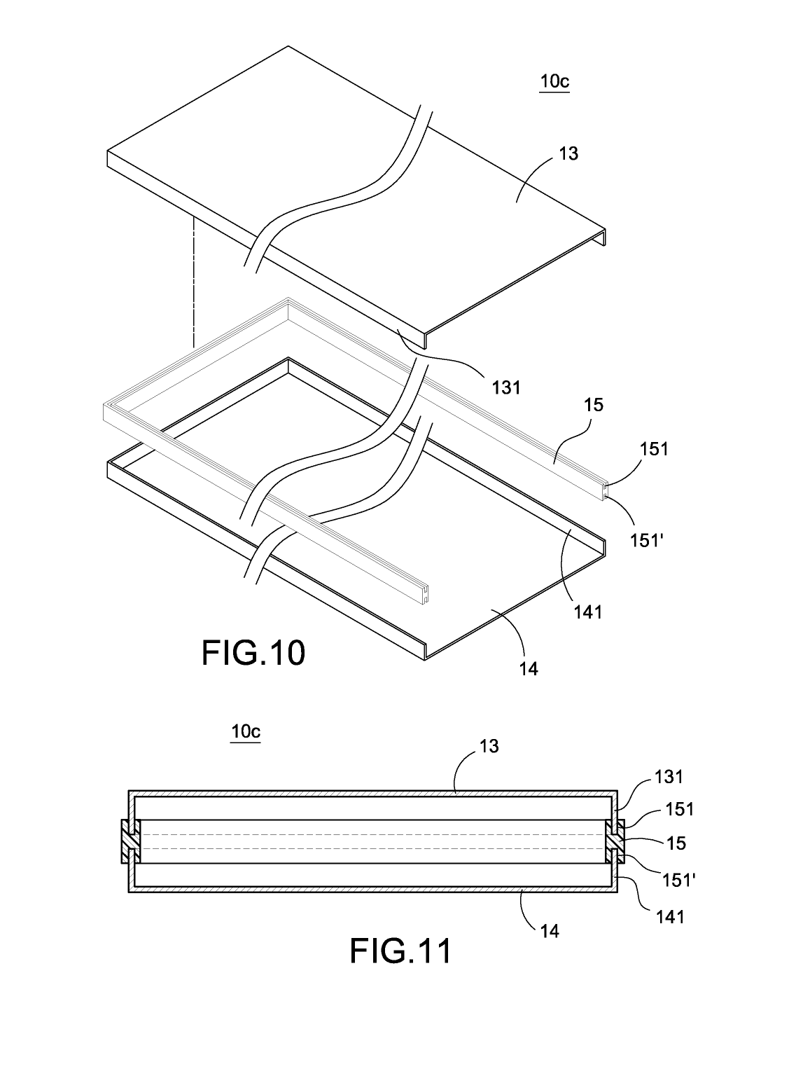

With reference to FIGS. 10 and 11 for the first and second schematic views of a hollow tube in accordance with the third preferred embodiment of the present invention respectively, the difference between this preferred embodiment and the aforementioned preferred embodiments resides on that the hollow tube 10a is changed to a hollow tube 10c, wherein the hollow main body 10c comprises an upper casing 13, a lower casing 14 and a pair of long stripes 15, and an U-shaped upper vertical plate 131 is formed on a side of the upper casing 13, and an U-shaped lower vertical plate 141 is formed on a side of the lower casing 14a, and the long stripe 15 has a H-shaped cross-section, and each long stripe 15 has a slide slot 151 formed separately at both ends of the long strip 15, wherein a side of each upper vertical plate 131 away from the upper casing 13 is slidably coupled into a slide slot 151 of each long stripe 15, and a side of each lower vertical plate 141 away from the lower casing 14 is slidably coupled into the other slide slot 151′ to engage the upper casing 13 with the lower casing 14.

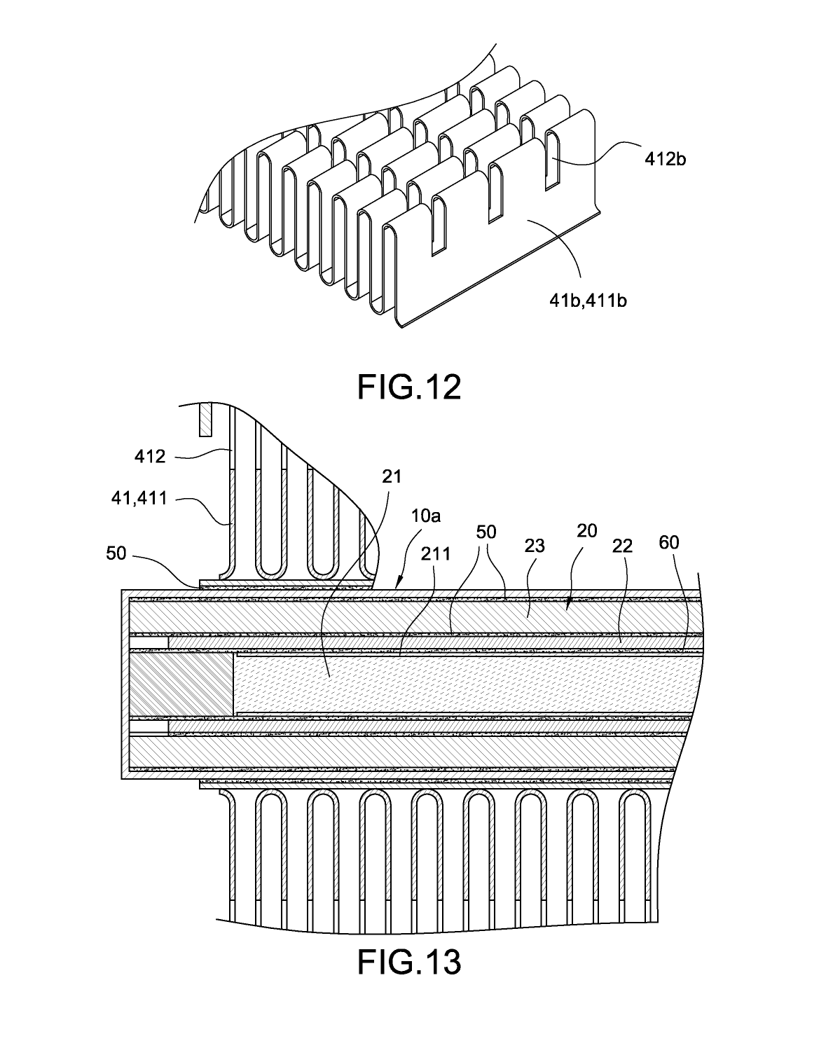

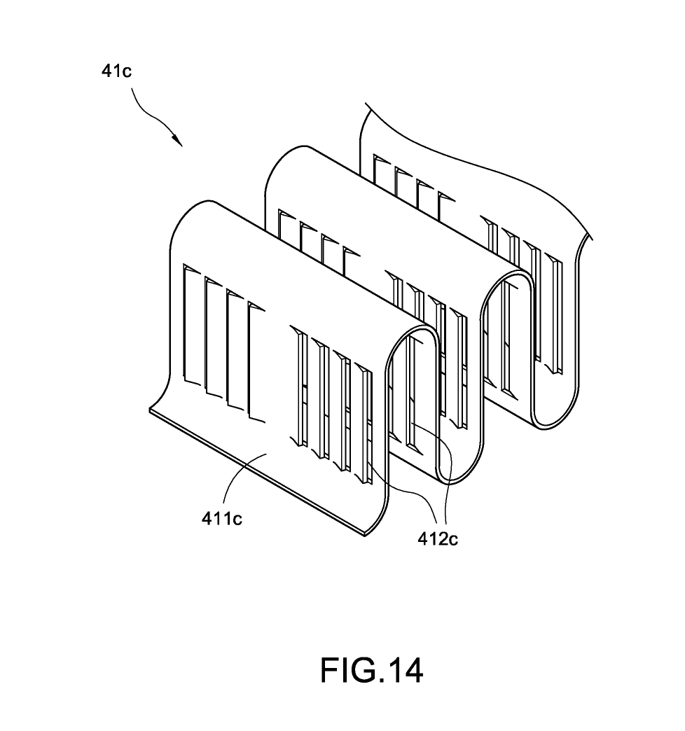

With reference to FIGS. 12 and 13 for schematic views of a fin and an application in accordance with the fourth preferred embodiment of the present invention respectively, the difference between this preferred embodiment and the previous preferred embodiments resides on that each fin 41 of the thermal diffuser 40 is changed to each fin 41b, wherein each fin 41b is formed by a wavy metal plate 411b, and each fin 41b has a plurality of cut grooves 412b formed on a side of the fin 41b, but the invention is not limited to such arrangement. The fixed plates 42 are coupled to both sides of each fin 41b respectively for increasing the contact area of each fin 41b with air to improve the effect of each thermal diffuser 40 to have a heat exchange with air. In addition, the thickness of the metal plate 411b can be reduced while maintaining the same heat dissipation effect, so as to achieve the effect of lowering the material cost.

With reference to FIG. 14 for a schematic view of a fin of the fifth preferred embodiment of the present invention, the difference between this preferred embodiment and the previous preferred embodiments resides on that each fin 41 of the thermal diffuser 40 is changed to each fin 41c, wherein each fin 41c is formed by a wavy metal plate 411c, and each fin 41c has a plurality of cut grooves 412c formed on a ventral side of the fin 41c, but the invention is not limited to such arrangement, and the fixed plates 42 are coupled to both sides of each fin 41c respectively for increasing the contact area of each fin 41c with air to improve the effect of each thermal diffuser 40 to have a heat exchange with air. In addition, the thickness of the metal plate 411c can be reduced while maintaining the same heat dissipation effect, so as to achieve the effect of lowering the material cost.

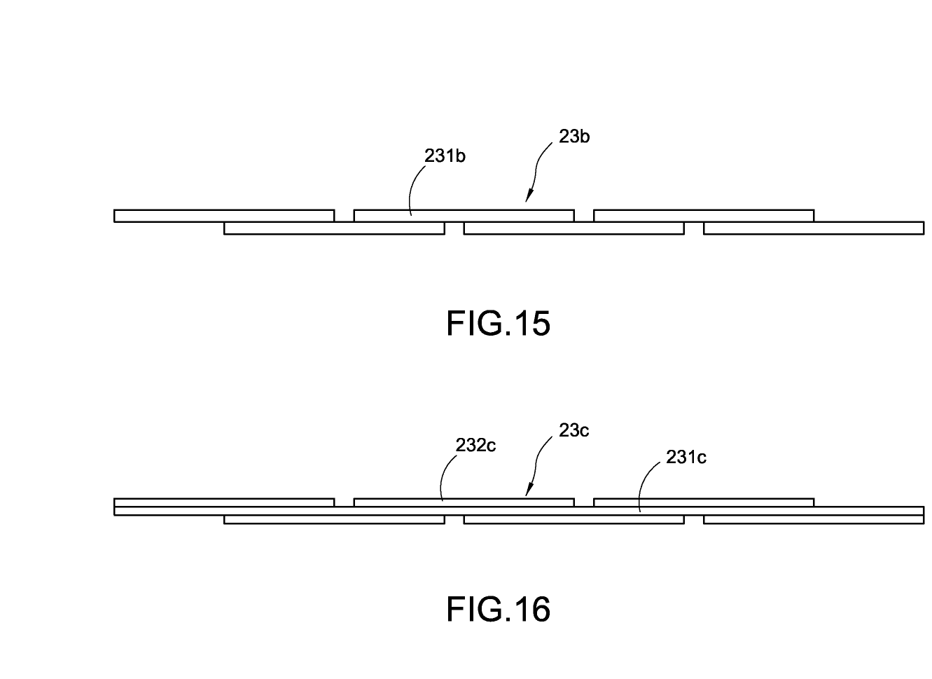

With reference to FIG. 15 for a schematic view of a thermal insulation plate of the sixth preferred embodiment of the present invention, the difference between this preferred embodiment and the previous preferred embodiments resides on that each thermal insulation plate 23 is changed to each thermal insulation plate 23b, wherein each thermal insulation plate 23b is formed by stacking a plurality of insulation units 231b one by one, and each insulation unit 231b is made of aluminum oxide, aluminum nitride, silicon nitride, silicon carbide, plastic or fiberglass.

With reference to FIG. 16 for a schematic view of a thermal insulation plate of the seventh preferred embodiment of the present invention, the difference between this preferred embodiment and the previous preferred embodiments resides on that each thermal insulation plate 23 is changed to each thermal insulation plate 23c, wherein each thermal insulation plate 23c is comprised of a primary insulation unit 231c and a plurality of secondary insulation units 232c, and the secondary insulation units 232c are arranged equidistantly from one another and coupled to both sides of each primary insulation unit 231c, and each primary insulation unit 231c and each secondary insulation unit 232c are made of aluminum oxide, aluminum nitride, silicon nitride, silicon carbide, plastic or fiberglass. The thickness of the thermal insulation plate 23c can be reduced while maintaining the same thermal insulation and conduction effects.

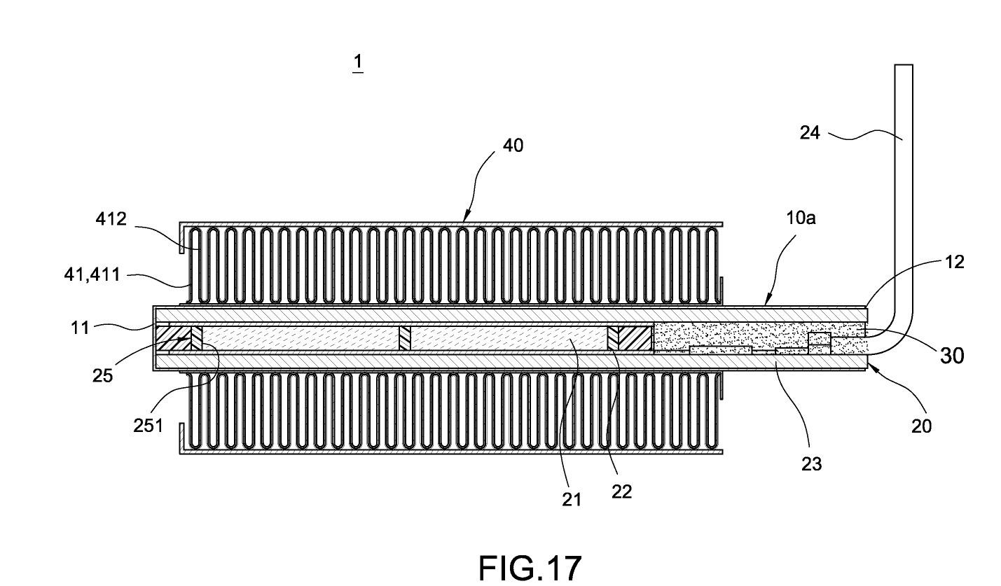

With reference to FIG. 17 for a cross-sectional view of the eighth preferred embodiment of the present invention, the difference between this preferred embodiment and the previous preferred embodiments resides on that the PTC heating module 20 further comprises a fixing frame 25, at least one fixing slot 251 formed at the fixing frame 25, wherein the PTC heating unit 21 is fixed into the fixing slot 251, and each electrode plate 22 is coupled to both sides of the PTC heating unit 21 by the thermal adhesive 60 to prevent the PTC heating unit 21 from being deviated from the correct position in the relatively difficult process of connecting each electrode plate 22 to both sides of the PTC heating unit 21 by the thermal adhesive 60. The fixing frame 25 is provided for achieving the effect of positioning the PTC heating unit 21 easily. In addition, the PTC heating unit 21 is fixed into the fixing slot 251, so that a gap is formed between the PTC heating unit 21 and the fixing frame 25 to maximize the effect of the characteristics of the PTC heating unit 21. In addition, the gap between the PTC heating unit 21 and the fixing frame 25 is provided for preventing a vacuum condition when filling the waterproof glue 30 into the hollow tube 10a, since the vacuum condition may cause a crack of breakage of the internal structure of the PTC heating module 20.

In summation of the description above, the present invention achieves the expected objectives and overcomes the drawbacks of the prior art as well as complying with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. An electric heating apparatus with a waterproof mechanism, comprising:
a hollow tube, having a closed end and an open end;
a positive temperature coefficient (PTC) heating module, having a pair of electrode plates, a PTC heating unit included between the pair of electrode plates and a conductive terminal separately coupled to each of the electrode plates, and the pair of electrode plates and the PTC heating unit being passed into the hollow tube from the open end; and
a waterproof glue, filled and sealed onto the open end, and each of the conductive terminals being exposed from the exterior of the waterproof glue.

2. The electric heating apparatus with a waterproof mechanism according to claim 1, further comprising a pair of thermal diffusers and a thermal insulation adhesive, and each of the thermal diffuser being coupled to external surfaces on both sides of the hollow tube through the thermal insulation adhesive by an insulation method.

3. The electric heating apparatus with a waterproof mechanism according to claim 2, wherein the thermal diffuser has a plurality of fins, and each of the fins is formed by a wavy metal plate, and the metal plate has a plurality of long concave marks formed on a side of the metal plate.

4. The electric heating apparatus with a waterproof mechanism according to claim 2, wherein the thermal diffuser has a plurality of fins, and each of the fins is formed by a wavy metal plate, and the metal plate has a plurality of cut grooves formed on a side of the metal plate.

5. The electric heating apparatus with a waterproof mechanism according to claim 2, wherein the thermal diffuser has a plurality of fins, and each of the fins is formed by a wavy metal plate, and the metal plate has a plurality of cut grooves formed on a ventral surface of the metal plate.

6. The electric heating apparatus with a waterproof mechanism according to claim 3, wherein the thermal diffuser further includes a pair of fixed plates coupled to both sides of each fin respectively.

7. The electric heating apparatus with a waterproof mechanism according to claim 4, wherein the thermal diffuser further includes a pair of fixed plates coupled to both sides of each fin respectively.

8. The electric heating apparatus with a waterproof mechanism according to claim 5, wherein the thermal diffuser further includes a pair of fixed plates coupled to both sides of each fin respectively.

9. The electric heating apparatus with a waterproof mechanism according to claim 1, further comprising a thermal adhesive, and the electrode plate is attached onto a side of the PTC heating unit by the thermal adhesive.

10. The electric heating apparatus with a waterproof mechanism according to claim 1, wherein the PTC heating unit has a metal layer formed on a surface of the PTC heating unit by a coating method, and the metal layer is made of aluminum or aluminum alloy.

11. The electric heating apparatus with a waterproof mechanism according to claim 1, wherein the PTC heating module further comprises a fixing frame, and the fixing frame has a at least one fixing slot formed thereon for fixing the PTC heating unit.

12. The electric heating apparatus with a waterproof mechanism according to claim 1, wherein the PTC heating module further has a pair of thermal insulation plates, and each of the thermal insulation plates is included between each the electrode plate and the hollow tube.

13. The electric heating apparatus with a waterproof mechanism according to claim 12, further comprising a thermal insulation adhesive, and a side of the thermal insulation plate being attached onto the electrode plate by an insulating method and the other side of the thermal insulation plate being attached onto an inner surface of the hollow tube by the insulating method.

14. The electric heating apparatus with a waterproof mechanism according to claim 12, wherein the thermal insulation plate is formed by arranging and combining a plurality of insulation units.

15. The electric heating apparatus with a waterproof mechanism according to claim 14, wherein the insulation unit is a rectangular, parallelogram or T-shaped body.

16. The electric heating apparatus with a waterproof mechanism according to claim 12, wherein the thermal insulation plate includes a primary insulation unit and a plurality of secondary insulation units, and the secondary insulation units are arranged equidistantly with one another and coupled to both sides of the primary insulation unit.

17. The electric heating apparatus with a waterproof mechanism according to claim 1, wherein the hollow tube includes an upper casing and a lower casing, and an U-shaped upper vertical plate is formed on a side of the upper casing, and an U-shaped lower vertical plate is formed on a side of the lower casing, and the upper vertical plate is coupled to the lower vertical plate.

18. The electric heating apparatus with a waterproof mechanism according to claim 17, wherein the upper vertical plate has an inwardly curved upper hook formed separately on both sides of the upper vertical plate, and an outwardly curved lower hook formed separately on both sides of the lower vertical plate, and each upper hook is latched with each lower hook.

19. The electric heating apparatus with a waterproof mechanism according to claim 17, wherein the hollow tube further includes a long stripe with a H-shaped cross-section, and a slide slot formed separately at both ends of the long stripe, and a side of the upper vertical plate away from the upper casing is slidably coupled into one of the slide slots, and a side of the lower vertical plate away from the lower casing is slidably coupled into the other slide slot.
